(19) United States
(12) Patent Application Publication
(10) Pub. No.: US 2017/0353772 A1
(43) Pub. Date: Dec. 7, 2017

(54) METHOD FOR CONTROLLING MPEG MEDIA TRANSPORT (MMT) SESSION AND APPARATUS PERFORMING THE SAME

(71) Applicant: Electronics and Telecommunications Research Institute, Daejeon (KR)

(72) Inventors: Changkyu LEE, Daejeon (KR); Sung Hei KIM, Daejeon (KR); Wook HYUN, Daejeon (KR); Shin Gak KANG, Sejong-si (KR); Juyoung PARK, Daejeon (KR)

(73) Assignee: Electronics and Telecommunications Research Institute, Daejeon (KR)

(21) Appl. No.: 15/610,838

(22) Filed: Jun. 1, 2017

(30) Foreign Application Priority Data
Jun. 3, 2016 (KR) 10-2016-0069617
Jul. 6, 2016 (KR) 10-2016-0085687
May 12, 2017 (KR) 10-2017-0059313

(51) Int. Cl. H04N 21/6587; H04N 21/633; H04N 21/443; H04N 21/854; H04L 29/06

(52) U.S. Cl. CPC H04N 21/6587; H04N 21/854; H04L 65/60; H04N 21/4432; H04N 21/633

(57) ABSTRACT

Provided is an operation method of a receiving entity, the method including setting a session with a sending entity based on bootstrap information; transmitting a signaling message corresponding to a media delivery request to the sending entity through the session; receiving media data from the sending entity through the session; and transmitting a signaling message corresponding to a media delivery control request to the sending entity through the session while receiving the media data.

### CROSS-REFERENCE TO RELATED APPLICATION(S)

This application claims the priority benefit of Korean Patent Application No. 10-2016-0069617 filed on Jun. 3, 2016, Korean Patent Application No. 10-2016-0085687 filed on Jul. 6, 2016, and Korean Patent Application No. 10-2017-0059313 filed on May 12, 2017, in the Korean Intellectual Property Office, the disclosures of which are incorporated herein by reference for all purposes.

### BACKGROUND

### 1. Field

One or more example embodiments relate to technology for controlling an MPEG media transport (MMT) session.

### 2. Description of Related Art

MPEG media transport (MMT) technology may be classified in a media processing unit (MPU) function area associated with a logical structure and a physical file format of media data, a signaling function area associated with a signaling message for an operation and control of a system, and a delivery function area associated with a method of transmitting any type of data that includes a signaling message and media data, and a presentation information area associated with a method of presenting media data. Among such areas, the signaling function area is used to define a signaling message associated with media consumption and media delivery.

### SUMMARY

According to an aspect, there is provided an operation method of a receiving entity, the method including setting a session with a sending entity based on bootstrap information; transmitting a signaling message corresponding to a media delivery request to the sending entity through the session; receiving media data from the sending entity through the session; and transmitting a signaling message corresponding to a media delivery control request to the sending entity through the session while receiving the media data.

The transmitting of the signal message corresponding to the media delivery control request may correspond to performing transmission according to in-band signaling.

The media delivery control request may include a fast forward request, a rewind request, or a pause request.

The signaling message corresponding to the media delivery control request may include a presentation start time.

The operation method of the receiving entity may further include receiving media data corresponding to the presentation start time or media data corresponding to a time closest to the presentation start time to the sending entity through the session.

The signaling message corresponding to the media delivery control request may include a number of MPEG media transport (MMT) assets controlled by the signaling message corresponding to the media delivery control request.

The operation method of the receiving entity may further include transmitting a signaling message corresponding to a media delivery stop request to the sending entity through the session.

According to another aspect, there is provided an operation method of a sending entity, the method including receiving a signaling message corresponding to a media delivery request from a receiving entity through a session that is set up based on bootstrap information; transmitting media data to the receiving entity through the session; receiving a signaling message corresponding to a media delivery control request from the receiving entity through the session while transmitting the media data; and controlling transmission of the media data based on the signaling message corresponding to the media delivery control request.

The receiving of the signaling message corresponding to the media delivery control request may correspond to performing receiving according to in-band signaling.

The media delivery control request may include a fast forward request, a rewind request, or a pause request.

The signaling message corresponding to the media delivery control request may include a presentation start time.

The controlling of the delivery may include transmitting media data corresponding to the presentation start time or media data corresponding to a time closest to the presentation start time to the receiving entity through the session.

The signaling message corresponding to the media delivery control request may include a number of MMT assets controlled by the signaling message corresponding to the media delivery control request.

The operation method of the sending entity may further include receiving a signaling message corresponding to a media delivery stop request from the receiving entity through the session.

According to another aspect, there is provided a receiving entity including a memory configured to store at least one instruction; and a controller configured to execute the instruction. The controller is configured to, by executing the instruction, set up a session with a sending entity based on bootstrap information, to transmit a signaling message corresponding to a media delivery request to the sending entity through the session, to receive media data from the sending entity through the session, and to transmit a signaling message corresponding to a media delivery control request to the sending entity through the session while receiving the media data.

According to example embodiments, it is possible to effectively perform a session control by performing the session control according to an in-band scheme.

Also, according to example embodiments, although a receiving entity does not support an MMT protocol, it is possible to perform a session control. Thus, encapsulation of a message or signaling according to another protocol for the session control may not be performed.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a bootstrap process according to an example embodiment;

FIG. 2 illustrates an example of a session control according to an example embodiment;

FIGS. 3A and 3B illustrate examples of a signaling message according to an example embodiment;

FIG. 4 is a flowchart illustrating an operation method of a receiving entity according to an example embodiment;

FIG. 5 is a flowchart illustrating an operation method of a sending entity according to an example embodiment;

FIG. 6 is a block diagram illustrating a receiving entity according to an example embodiment; and

FIG. 7 is a block diagram illustrating a sending entity according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Prior to describing example embodiments, terms are briefly described.

A media processing unit (MPU) may represent a unit of media data independently consumable at an MPEG media transport (MMT). An MPU identifier (ID) may be included in a header of the MPU.

An MMT asset or an asset may represent a logical data entity that includes at least one MPU. The MMT asset may include MPUs having the same asset ID.

An MMT package or a package may include at least one MMT asset.

The MMTP packet may represent data generated or consumed by an MMT protocol or a format of the data.

Hereinafter, the example embodiments are described.

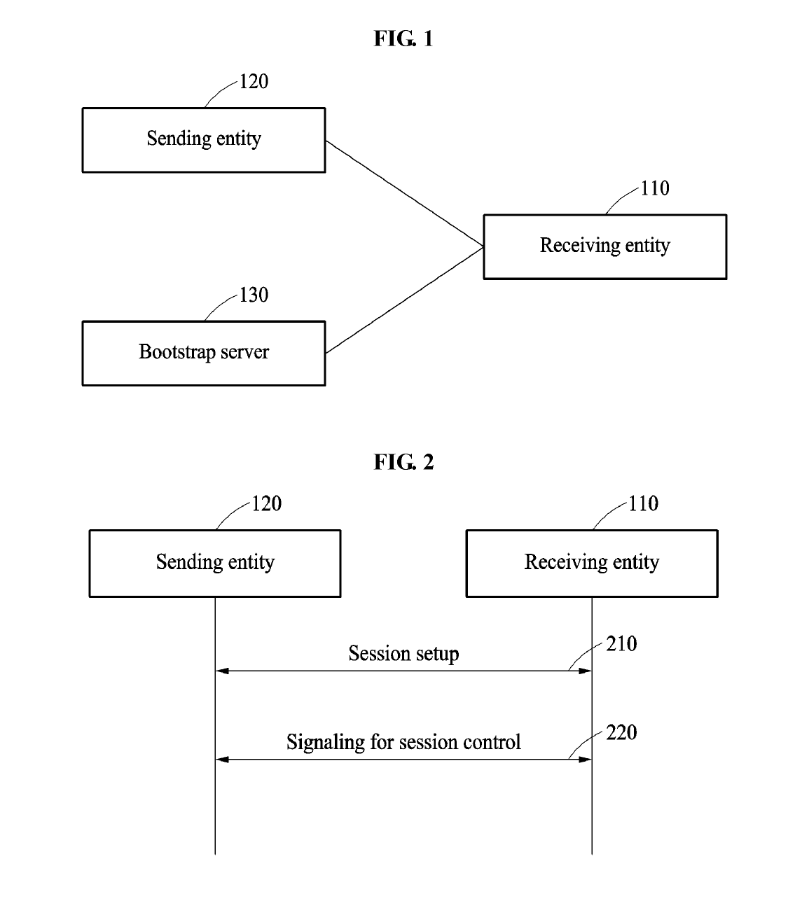

FIG. 1 is a diagram illustrating a bootstrap process according to an example embodiment.

FIG. 1 illustrates a receiving entity 110, a sending entity 120, and a bootstrap server 130.

The receiving entity 110 and/or the sending entity 120 may support an MMT protocol. In this case, the receiving entity 110 may be represented as an MMT receiving entity and the sending entity 120 may be represented as an MMT sending entity.

Each of the receiving entity 110 and the sending entity 120 may correspond to a peer. In this case, the receiving entity 110 and the sending entity 120 may perform a peer-to-peer (P2P) communication. Depending on example embodiments, the receiving entity 110 may correspond to a client and the sending entity 120 may correspond to a media server.

The receiving entity 110 may receive bootstrap information from the sending entity 120. Here, the bootstrap information may include a package access (PA) message of ISO/IEC 23008-1. The PA message may include information about a signaling table used for an approach to a package. That is, the bootstrap information may include a PA table. Depending on example embodiments, the receiving entity 110 may receive bootstrap information from the bootstrap server 130. Here, the bootstrap information may be based on a session description protocol (SDP).

The receiving entity 110 sets up a session with the sending entity 120 based on the bootstrap information. That is, the receiving entity 110 may set up a session for media delivery with the sending entity 120 by retrieving the bootstrap information.

Once the session is set up between the receiving entity 110 and the sending entity 120, MMT signaling for a session control may be performed. Hereinafter, a description is made with reference to FIG. 2.

FIG. 2 illustrates an example of a session control according to an example embodiment.

Referring to FIG. 2, in operation 210, the receiving entity 110 sets up a session with the sending entity 120. Here, the session may correspond to a media delivery session.

Once the session is set up between the receiving entity 110 and the sending entity 120, signaling for session control may be performed in operation 220.

For example, a real-time streaming protocol (RTSP) or a hypertext transfer protocol (HTTP) may be used to perform the session control. When the RTSP is used, the sending entity 120 needs to encapsulate an RTSP message into an MMT signaling message. When the HTTP is used, the sending entity 120 needs to encapsulate an HTTP message into the MMT signaling message. Also, when the receiving entity 110 receives the MMT signaling message in which the RTSP message or the HTTP message is encapsulated, the receiving entity 110 needs to parse the MMT signaling message and the RTSP message or the HTTP message for the session control. That is, when the RTSP or the HTTP is used for the session control, encapsulation and parsing of the MMT signaling message may be performed. Accordingly, the efficiency of the session control may be degraded.

As another example, WebSocket may be used for the session control. In this case, additional signaling is required in addition to MMT signaling. That is, the receiving entity 110 and the sending entity 120 need to exchange a WebSocket-based signaling message as well as the MMT signaling message. The receiving entity 110 and the sending entity 120 need to perform signaling according to MMT and signaling according to Web Socket.

In the meantime, when the receiving entity 110 does not support another protocol, for example, RTSP, HTTP, and WebSocket, aside from the MMT protocol, a session control based on the other protocol may not be performed.

Accordingly, considering a case in which the receiving entity 110 does not support the other protocol aside from the MMT protocol and/or the efficiency of session control, an in-band session control may be performed. Hereinafter, the in-band session control is described.

According to an example embodiment, the receiving entity 110 transmits an MMT signaling message corresponding to a media delivery request to the sending entity 120 through a session.

The sending entity 120 transmits media data to the receiving entity 110 based on information included in the MMT signaling message corresponding to the media delivery request. Here, the media data may represent at least one MPU or an asset that includes at least one MPU.

The receiving entity 110 transmits an MMT signaling message corresponding to a media delivery control request through the session while receiving the media data through the session. The receiving entity 110 may request the sending entity 120 for a media delivery control, for example, fast forward, rewind, or pause, while receiving the media data. A parameter, such as a speed of fast forward, a speed of rewind, etc., may be determined through negotiation between the receiving entity 110 and the sending entity 120. That is, the receiving entity 110 and the sending entity 120 may negotiate a parameter in operation 210.

When the receiving entity 110 is to terminate media reception, the receiving entity 110 transmits an MMT signaling message corresponding to a media delivery stop request to the sending entity 120 through the session. Once the sending entity 120 receives the MMT signaling message corresponding to the media delivery stop request, the sending entity 120 does not transmit media data to the receiving entity 110.

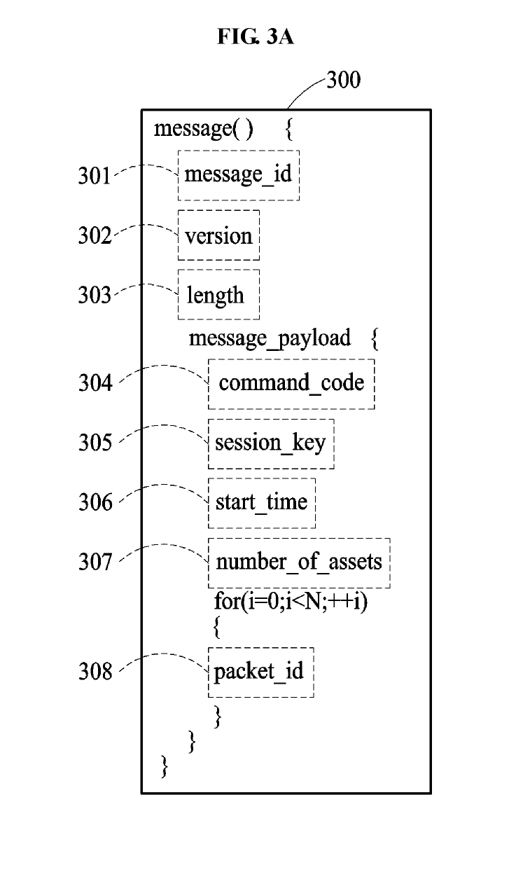

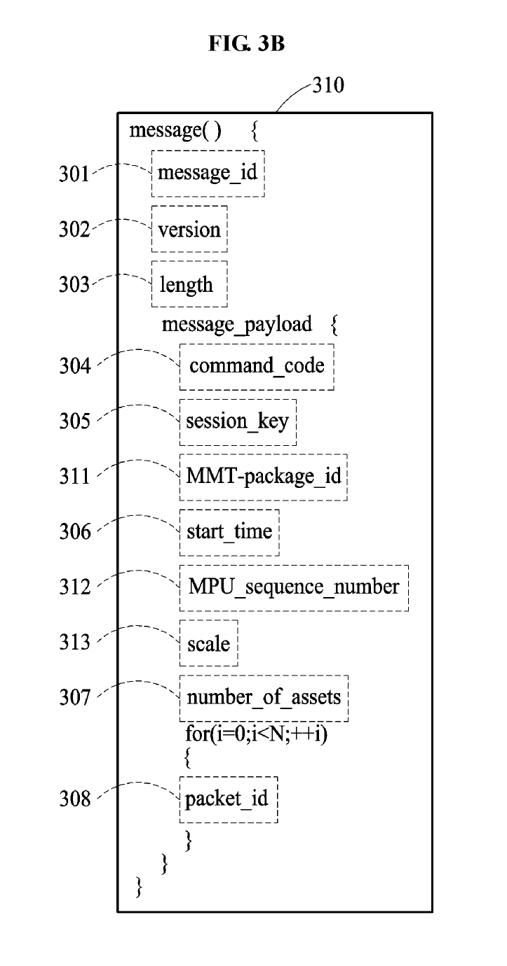

FIGS. 3A and 3B illustrate examples of a signaling message according to an example embodiment.

A format of a signaling message 300 of FIG. 3A and/or a format of a signaling message 310 of FIG. 3B may be applied to one of or all of MMT signaling messages described with reference to FIG. 2.

Referring to FIG. 3A, the signaling message 300 includes a message_id field 301, a version field 302, a length field 303, a command_code field 304, a session_key field 305, a start_time field 306, a number_of_asset field 307, and a packet_id field 308.

The message_id field 301 indicates an ID of the signaling message 300.

The version field 302 indicates a version of the signaling message 300. A value set to the version field 302 may vary every time the receiving entity 110 transmits the signaling message 300. The sending entity 120 may verify whether the signaling message 300 is a recent message based on the value set to the version field 302. That is, the sending entity 120 may verify whether the signaling message 300 is new based on the version field 302.

The length field 303 indicates a length of the signaling message 300. According to an example embodiment, a value of a remaining length that excludes a length of the message_id field 301, a length of the version field 302, and a length of the length field 303 from the entire length of the signaling message 300 may be set to the length field 303. That is, a value of a length value from a length from the command_code field 304 to a length of the packet_id field 308 may be set to the length field 303.

The command_code field 304 indicates a specific operation of session control. The command_code field 304 indicates a type of session control. Types of session control may include one of play or start, pause, resume, fast forward, rewind, and stop of media delivery, or combination thereof. For example, the “command_code field 304=0x01” may indicate play or start of media delivery through a media delivery session, “command_code field 304=0x02” may indicate stop of media delivery, and “command_code field 304=0x03” may indicate pause of media delivery. Also, “command_code field 304=0x04” may indicate fast forward and “command_code field 304=0x05” may indicate rewind.

A random value for distinguishing a media delivery session between the sending entity 120 and the receiving entity 110 from other media delivery sessions may be set to the session_key field 305. That is, the session_key field 305 may indicate a session_key that is randomly generated to ensure identification of a media delivery session.

The start_time field 306 indicates a presentation time or a control time. If the receiving entity 110 is using a real-time streaming service, the start_time field 306 may indicate the presentation time. If the receiving entity 110 is using a video on demand (VOD) service, the start_time field 306 may indicate the control time. It is described below. The receiving entity 110 may set a time to the start_time field 306. That is, a desired time of the receiving entity 110 may be set to the start_time field 306. The sending entity 120 may transmit, to the receiving entity 110, media data corresponding to a time that is set to the start_time field 306 of the signaling message 300 or media data corresponding to a time closest to the set time.

Depending on example embodiments, a difference between a time set to the start_time field 306 and a time of media data may be equal to a difference between the time set to the start_time field 306 and a time of another media data. For example, when a time corresponding to MPU 1 is a, a time corresponding to MPU 2 is b, and a time set to the start_time field 306 is c, a difference between c and a may be equal to a difference between c and b. In this case, the sending entity 120 may select media data having a lower presentation time. The sending entity 120 may select media data corresponding to a time ahead of the time set to the start_time field 306. In the above example, if a<b, the sending entity 120 may select MPU 1 corresponding to a. If b<a, the sending entity 120 may select MPU 2 corresponding to b.

Depending on example embodiments, a format of the start_time field 306 may be a short-format that is defined in an IETF RFC 5905 Network Time Protocol version 4.

The number_of_asset field 307 indicates the number of assets controlled through the signaling message 300. For example, if ten assets are to be controlled, 10 may be set to the number_of_asset field 307 through the receiving entity 110.

To classify or identify an asset to be controlled through the signaling message 300 at an MMTP packet level, the signaling message 300 may include the packet_id field 308 indicating a field for classifying or identifying an asset. When the signaling message 300 is configured to include the packet_id field 308, the receiving entity 110 and the sending entity 120 may exchange mapping information between a packet ID and an asset ID through another signaling message with the signaling message 300. For example, the sending entity 120 may transmit another signaling message corresponding to the receiving entity 110 and the receiving entity 110 may receive corresponding mapping information through a corresponding signaling message. Here, the other signaling message includes mapping information between packet_id and asset_id.

When session control is required, the receiving entity 110 may set, to the packet_id field 308, packet_id that is mapped to asset_id of an asset to be controlled by referring to corresponding mapping information.

Depending on example embodiments, to classify or identify an asset to be controlled through the signaling message 300 at an asset level, the signaling message 300 may include an asset_id field instead of including the packet_id field 308. The asset_id field may indicate a field for classifying or identifying an asset, which is similar to the packet_id field 308. When the session control is required, the receiving entity 110 may set asset_id of an asset to be controlled to the asset_id field.

Referring to FIG. 3B, compared to the signaling message 300 of FIG. 3A, the signaling message 310 may further include an MMT_package_id field 311, an MPU_sequence_number field 312, and a scale field 313. The signaling message 310 of FIG. 3B is provided as an example only. Compared to the signaling message 300, the signaling message 310 may further include one of the MMT_package_id field 311, the MPU_sequence_number field 312, and the scale field 313, or combination thereof. Hereinafter, each of the MMT_package_id field 311, the MPU_sequence_number field 312, and the scale field 313 is described.

The MMT_package_id field 311 is a field for classifying an MMT package. The MMT_package_id field 311 may indicate an identifier of the MMT package. If a session key is absent or in a single session, a plurality of packages may be transmitted. In this case, a package associated with session control may be classified or identified through the MMT_package_id field 311.

The MPU_sequence_number field 312 may indicate a field for transmission from specific media data, for example, media data corresponding to a subsequent time or a previous time of media data that the receiving entity 110 is currently receiving. The receiving entity 110 may request the sending entity 120 for the session control through the MPU_sequence_number field 312. For example, when it is assumed that media data corresponding to “MPU ID=10” is currently played at the receiving entity 110, the receiving entity 110 may desire media data, for example, an image or audio, corresponding to “MPU ID=20”. In this case, the receiving entity 110 may transmit the signaling message 310 that includes the MPU_sequence_number field 312 set to “MPU ID=20”. That is, the receiving entity 110 may request the sending entity 120 to transmit media data corresponding to “MPU ID=20” through the MPU_sequence_number field 312. As another example, the receiving entity 110 may request the sending entity 120 to fast forward media data from “MPU ID=10” through the MPU_sequence_number field 312. Here, the receiving entity 110 may set a speed value to the scale field 313.

Depending on example embodiments, the signaling message 310 may include one of or all of the start_time field 306 and the MPU_sequence_number field 312.

The scale field 313 may indicate a speed of fast forward or rewind. For example, when it is assumed that the receiving entity 110 desires to fast forward currently playing media data corresponding to “MPU ID=10”, the receiving entity 110 may transmit, to the sending entity 120, the signaling message 310 that includes the scale field 313 to which a specific value is set. The receiving entity 110 may request the sending entity 120 to fast forward the media data at 2× speed or fast forward the media data at 4x speed through the scale field 313.

Depending on example embodiments, the signaling message 310 may include the aforementioned asset_id field instead of including the packet_id field 308.

In a case in which the receiving entity 110 is using a real-time streaming service and in a case in which the receiving entity 110 is using a VOD service, the receiving entity 110 and/or the sending entity 120 may operate differently. Operations of the receiving entity 110 and the sending entity 120 in the case of using the real-time streaming service are described.

The receiving entity 110 may transmit, to the sending entity 120, the signaling message 300 or 310 that includes the command_code field 304 to which play or start is set and the start_time field 306 to which a time is set. The sending entity 120 may transmit, to the receiving entity 110, media data corresponding to the time that is set to the start_time field 306. In the case of the real-time streaming service, the start_time field 306 may indicate a presentation time that is synchronized with a time of a server. Accordingly, the receiving entity 110 and another receiving entity may receive media data corresponding to the same time from the sending entity 120. In the case of the real-time streaming service, receiving entities may play media data corresponding to the same time.

Once the sending entity 120 receives the signaling message 300 or 310 that includes the command_code field 304 set to pause, the sending entity 120 may pause streaming. When the command_code field 304 of the signaling message 300 or 310 received by the sending entity 120 is set to pause, the sending entity 120 may pause streaming. Here, once the sending entity 120 receives, from the receiving entity 110, the signaling message 300 or 310 that includes the command_code field 304 set to play or resume, the sending entity 120 may resume transmission from media data corresponding to a current time instead of resuming transmission from media data corresponding to a paused time.

When the command_code field 304 is set to stop, the sending entity 120 may terminate streaming. When the command_code field 304 is set to stop, the sending entity 120 may terminate the session.

The real-time streaming service may not support a random seek. Here, the random seek may indicate an action capable of arbitrarily selecting or determining a presentation time. Also, the real-time streaming service may not support fast forward or rewind. Accordingly, the receiving entity 110 may not set fast forward or rewind to the command_code field 304. Also, the receiving entity 110 may not set any speed to the scale field 313.

Hereinafter, operations of the receiving entity 110 and the sending entity 120 in the case of the VOD service are described.

The receiving entity 110 may transmit, to the sending entity 120, the signaling message 300 or 310 that includes the command_code field 304 to which play or start is set and the start_time field 306 to which the time is set. The sending entity 120 may transmit, to the receiving entity 110, media data corresponding to the time that is set to the start_time field 306. In the case of the VOD service, the start_time field 306 may indicate the control time. Accordingly, the receiving entity 110 and another receiving entity may receive media data corresponding to different times from the sending entity 120. In the case of the VOD service, receiving entities may play media data corresponding to different times.

The receiving entity 110 may desire to pause media data being played. In this case, the receiving entity 110 may transmit, to the sending entity 120, the signaling message 300 or 310 that includes the command_code field 304 set to pause and the start_time field 306 to which the time is set. The sending entity 120 may pause transmission of media data corresponding to the time that is set to the start_time field 306. Here, once the sending entity 120 receives, from the receiving entity 110, the signaling message 300 or 310 that includes the command_code field 304 set to play or resume, the sending entity 120 may resume transmission from media data corresponding to the paused time. Depending on example embodiments, the receiving entity 110 may transmit, to the sending entity 120, the signaling message 300 or 310 that includes the command_code field 304 set to pause. Here, the signaling message 300 or 310 may not include start_time field. Once the sending entity 120 receives the signaling message 300 or 310 that includes the command_code field 304 set to pause and does not include start_time field, the sending entity 120 may immediately pause transmission of media data. Here, when the sending entity 120 receives, from the receiving entity 110, the signaling message 300 or 310 that includes the command_code field 304 set to play or resume and the start_time field 306, the sending entity 120 may resume transmission of media data corresponding to the time that is set to the start_time field 306.

The VOD service may support a random seek. When the receiving entity 110 desires the random seek, the receiving entity 110 may transmit, to the sending entity 120, the signaling message 300 or 310 that includes the command_code field 304 to which play or start is set and the start_time field 306 to which the time is set. The sending entity 120 may perform the random seek by transmitting, to the receiving entity 110, media data corresponding to the time that is set to the start_time field 306.

The VOD service may support fast forward or rewind. In this case, the receiving entity 110 may transmit, to the sending entity 120, the signaling message 300 or 310 that includes the command_code field 304 to which fast forward or rewind is set, the start_time field 306 to which the time is set, and the scale field 313 to which a speed value is set. The sending entity 120 may fast forward or rewind media data based on the time set to the start_time field 306. Here, the fast forward or rewind operation may be performed at a speed corresponding to the speed value set to the scale field 313 included in the signaling message 300 or 310 that is received from the receiving entity 110.

When the command_code field 304 is set to stop, the sending entity 120 may terminate the session.

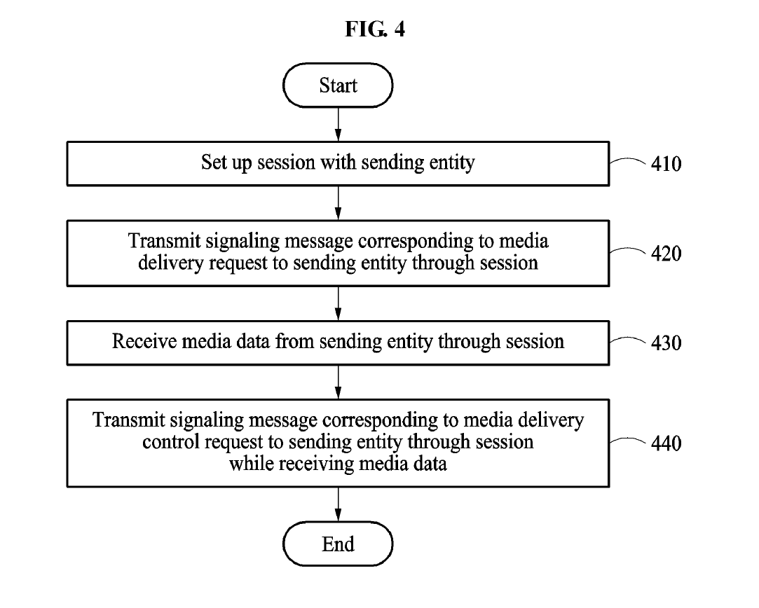

FIG. 4 is a flowchart illustrating an operation method of a receiving entity according to an example embodiment.

Referring to FIG. 4, in operation 410, the receiving entity 110 sets up a session with the sending entity 120. For example, the receiving entity 110 may set up the session based on bootstrap information.

In operation 420, the receiving entity 110 transmits a signaling message corresponding to a media delivery request to the sending entity 120 through the session. The signaling message may have the format of FIG. 3A or 3B. The receiving entity 110 may transmit, to the sending entity 120, a signaling message that includes “command_code field 304=0x01”.

In operation 430, the receiving entity 110 receives media data from the sending entity 120 through the session.

In operation 440, the receiving entity 110 transmits a signaling message corresponding to a media delivery control request to the sending entity 120 through the session while receiving the media data. The signaling message may have the format of FIG. 3A or 3B. For example, if the receiving entity 110 desires play at time=a, the receiving entity 110 may transmit, to the sending entity 120, a signaling message that includes “start_time field 306=a”. Once the sending entity 120 receives the signaling message that includes “start_time field 306=a”, the sending entity 120 may retrieve media data corresponding to a or media data corresponding to a time closest to a, and may transmit the retrieved media data to the receiving entity 110.

According to an example embodiment, the receiving entity 110 may transmit, to the sending entity 120, an MMT signaling message having the format of the signaling message 300 of FIG. 3A or the format of the signaling message 310, so that session control may be performed using an in-band scheme. Through the session control, the receiving entity 110 may start or stop a media delivery session and may efficiently perform a function, such as fast forward or rewind.

The description made above with reference to FIGS. 1 through 3B may be applicable to the example embodiment of FIG. 4 and a further description is omitted here.

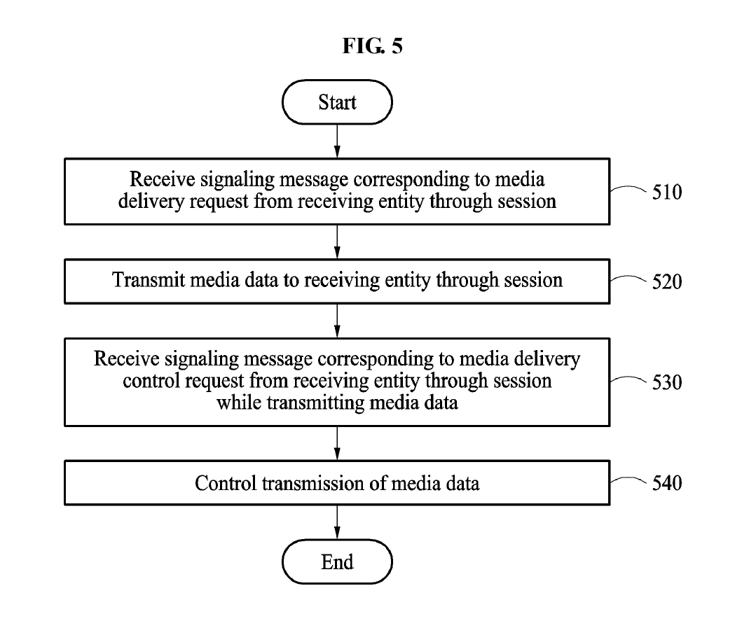

FIG. 5 is a flowchart illustrating an operation method of a sending entity according to an example embodiment.

Referring to FIG. 5, in operation 510, the sending entity 120 receives a signaling message corresponding to a media delivery request from the receiving entity 110 through a session.

In operation 520, the sending entity 120 transmits media data to the receiving entity 110 through the session.

In operation 530, the sending entity 120 receives a signaling message corresponding to a media delivery control request from the receiving entity 110 through the session while transmitting media data.

In operation 540, the sending entity 120 controls transmission of media data based on the signaling message corresponding to the media delivery control request.

The description made above with reference to FIGS. 1 through 3B may be applied to the example embodiment of FIG. 4 and a further description is omitted here.

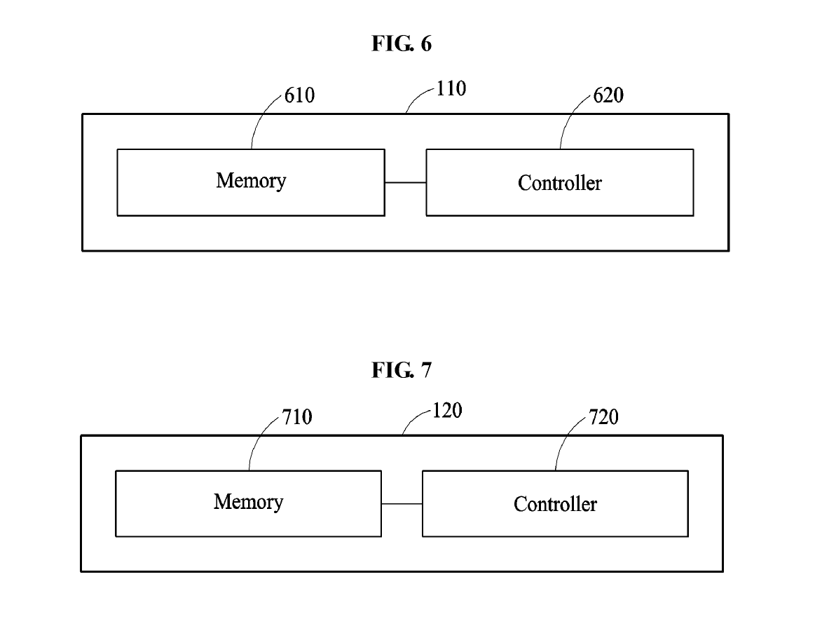

FIG. 6 is a block diagram illustrating an example of a receiving entity according to an example embodiment.

Referring to FIG. 6, the receiving entity 110 includes a memory 610 and a controller 620.

The memory 610 stores at least one instruction.

The controller 620 may perform operations 410 through 440 of FIG. 4 by executing the at least one instruction.

FIG. 7 is a block diagram illustrating an example of a sending entity according to an example embodiment.

Referring to FIG. 7, the sending entity 120 includes a memory 710 and a controller 720.

The memory 710 stores at least one instruction.

The controller 720 may perform operations 510 through 540 of FIG. 5 by executing the at least one instruction.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method of a receiving entity, the method comprising:
setting a session with a sending entity based on bootstrap information;
transmitting a signaling message corresponding to a media delivery request to the sending entity through the session;
receiving media data from the sending entity through the session; and
transmitting a signaling message corresponding to a media delivery control request to the sending entity through the session while receiving the media data.

2. The method of claim 1, wherein the transmitting of the signal message corresponding to the media delivery control request corresponds to performing transmission according to in-band signaling.

3. The method of claim 1, wherein the media delivery control request comprises a fast forward request, a rewind request, or a pause request.

4. The method of claim 1, wherein the signaling message corresponding to the media delivery control request comprises a presentation start_time.

5. The method of claim 4, further comprising:
receiving media data corresponding to the presentation start_time or media data corresponding to a time closest to the presentation start_time to the sending entity through the session.

6. The method of claim 1, wherein the signaling message corresponding to the media delivery control request comprises a number of MPEG media transport (MMT) assets controlled by the signaling message corresponding to the media delivery control request.

7. The method of claim 1, further comprising:
transmitting a signaling message corresponding to a media delivery stop request to the sending entity through the session.

8. An operation method of a sending entity, the method comprising:
receiving a signaling message corresponding to a media delivery request from a receiving entity through a session that is set up based on bootstrap information;
transmitting media data to the receiving entity through the session;
receiving a signaling message corresponding to a media delivery control request from the receiving entity through the session while transmitting the media data; and
controlling transmission of the media data based on the signaling message corresponding to the media delivery control request.

9. The method of claim 8, wherein the receiving of the signaling message corresponding to the media delivery control request corresponds to performing receiving according to in-band signaling.

10. The method of claim 8, wherein the media delivery control request comprises a fast forward request, a rewind request, or a pause request.

11. The method of claim 8, wherein the signaling message corresponding to the media delivery control request comprises a presentation start_time.

12. The method of claim 11, wherein the controlling of the delivery comprises transmitting media data corresponding to the presentation start_time or media data corresponding to a time closest to the presentation start_time to the receiving entity through the session.

13. The method of claim 8, wherein the signaling message corresponding to the media delivery control request comprises a number of MPEG media transport (MMT) assets controlled by the signaling message corresponding to the media delivery control request.

14. The method of claim 8, further comprising:
receiving a signaling message corresponding to a media delivery stop request from the receiving entity through the session.

15. A receiving entity comprising:
a memory configured to store at least one instruction; and
a controller configured to execute the instruction,
wherein the controller is configured to, by executing the instruction, set up a session with a sending entity based on bootstrap information, to transmit a signaling message corresponding to a media delivery request to the sending entity through the session, to receive media data from the sending entity through the session, and to transmit a signaling message corresponding to a media delivery control request to the sending entity through the session while receiving the media data.
